(19) United States
(12) Patent Application Publication
(10) Pub. No.: US 2006/0046574 A1
(43) Pub. Date: Mar. 2, 2006

(54) Electrical connector for cards

(76) Inventors: Daisuke Nozue, Kanagawa (JP); Takafumi Kubo, Tokyo (JP)

Correspondence Address: BARLEY SNYDER, LLC, 1000 WESTLAKES DRIVE, SUITE 275, BERWYN, PA, 19312, US

(21) Appl. No.: 11/215,408

(22) Filed: Aug. 30, 2005

(30) Foreign Application Priority Data
Aug. 30, 2004 (JP) 2004-250873

(51) Int. Cl. H01R 24/00

(52) U.S. Cl. 439/630

(57) ABSTRACT

An electrical connector for cards is enabled to accommodate a plurality of types of card devices having different numbers of contact points. A housing is capable of receiving a first card, having conductive pads at predetermined positions, and a second card 250, having a plurality of conductive pads 252a, 252b at least one region that corresponds to the conductive pads of the first card. A plurality of contacts 36, 38, 46, 48, 56, and 58, for contacting the plurality of conductive pads 252a, 252b of the second card 250, are provided within the region that corresponds to the conductive pad of the first card.

### FIELD OF THE INVENTION

The present invention relates to an electrical connector for cards, to which card type devices are connected. Particularly, the present invention relates to an electrical connector for cards that receives a plurality of different types of cards, and has contacts for contacting conductive pads of the cards.

### BACKGROUND

There is a known dual purpose card edge connector, for receiving two types of cards and connecting with the conductive pads thereof (refer to U.S. Pat. No. 4,869,672, FIGS. 6 and 8). This card edge connector comprises a positioning means, for determining insertion positions of cards, provided within a slot, into which cards are inserted. The positioning means regulates insertion depths of cards, according to the type thereof. Thereby, conductive pads of both types of cards are enabled to establish electrical connections with corresponding contacts.

There is also known a PC card provided with a mechanical switch, to switch operating modes of the card, for cases in which a plurality of cards are employed (refer to Japanese Unexamined Patent Publication No. 10(1998)-171938, FIGS. 1 and 4).

The aforementioned known connector enables reception of two types of cards, having conductive pads at different pitches, to establish electrical connections therewith. However, the connector requires an additional component, the positioning member and the aforementioned known PC card requires the switching means.

### SUMMARY

The present invention has been developed in view of these circumstances. It is an object of the present invention to provide an electrical connector for cards that can accommodate a plurality of types of card type devices, having different numbers of contact points.

The electrical connector for cards of the present invention comprises:
a housing, which is capable of receiving a first card, having conductive pads at predetermined positions, and a second card, having a plurality of conductive pads at least one region that corresponds to the conductive pads of the first card; and
a plurality of contacts for contacting the plurality of conductive pads of the second card, provided within the region that corresponds to the conductive pads of the first card.

As an aspect of the present invention, a configuration may be adopted, wherein:
contact portions of the plurality of contacts for contacting the plurality of conductive pads of the second card, provided within the region that corresponds to the conductive pads of the first card are arranged along the insertion/extraction direction of the second card. In this case, the contacts may be provided along the same direction, or provided such that they face the contact points.

As an alternative aspect of the present invention, a configuration may be adopted, wherein:

contact portions of the plurality of contacts for contacting the plurality of conductive pads of the second card, provided within the region that corresponds to the conductive pads of the first card are arranged along a direction that intersects the insertion/extraction direction of the second card.

Here, the term “card” includes comparatively narrow recording media, such as Memory Sticks (Registered Trademark of Sony KK), as well as wide and thin planar cards, such as cash cards. In addition, the referents of the term “card” are not limited to recording media, and may be card type devices having communication functions.

The electrical connector for cards of the present invention is capable of receiving the first card, having its conductive pads at the predetermined positions, and the second card, having the plurality of conductive pads at least one regions that corresponds to a conductive pad of the first card. The plurality of contacts, for contacting the plurality of conductive pads of the second card, are provided within the region that corresponds to the conductive pad of the first card. Therefore, the electrical connector for cards of the present invention exhibits the following advantageous effect.

Compatibility for a plurality of types of cards is secured, without providing a positioning member for each type of card, or providing an operating mode switching means on the card.

### BRIEF DESCRIPTION OF THE DRAWINGS

FIGS. 1A and 1B illustrate an electrical connector for cards according to a first embodiment of the present invention, wherein FIG. 1A is a plan view, and FIG. 1B is a side view.

FIG. 2 is a vertical sectional view of the electrical connector for cards of FIG. 1.

FIG. 3 is a partial enlarged perspective view that illustrates the mounting state of contacts of the electrical connector for cards of FIG. 1.

FIG. 4 is a vertical sectional view of an electrical connector for cards according to a second embodiment of the present invention.

FIG. 5 is a partial sectional view of the electrical connector for cards of FIG. 4, taken along line V-V of FIG. 4.

FIG. 6 is a vertical sectional view of an electrical connector for cards according to a third embodiment of the present invention.

FIG. 7 is a partial enlarged plan view of the electrical connector for cards of FIG. 6 that illustrates the state in which contacts are arranged.

FIGS. 8A, 8B, and 8C are partial enlarged sectional views that illustrate states in which the contacts of the connectors of each embodiment are in contact with a card, wherein FIG. 8A illustrates the first embodiment, FIG. 8B illustrates the second embodiment, and FIG. 8C illustrates the third embodiment.

FIGS. 9A and 9B are schematic diagrams of the front edges of cards, wherein FIG. 9A illustrates a card that has a great number of electrodes, and FIG. 9B illustrates a card that has a small number of electrodes.

### DESCRIPTION OF THE EMBODIMENTS

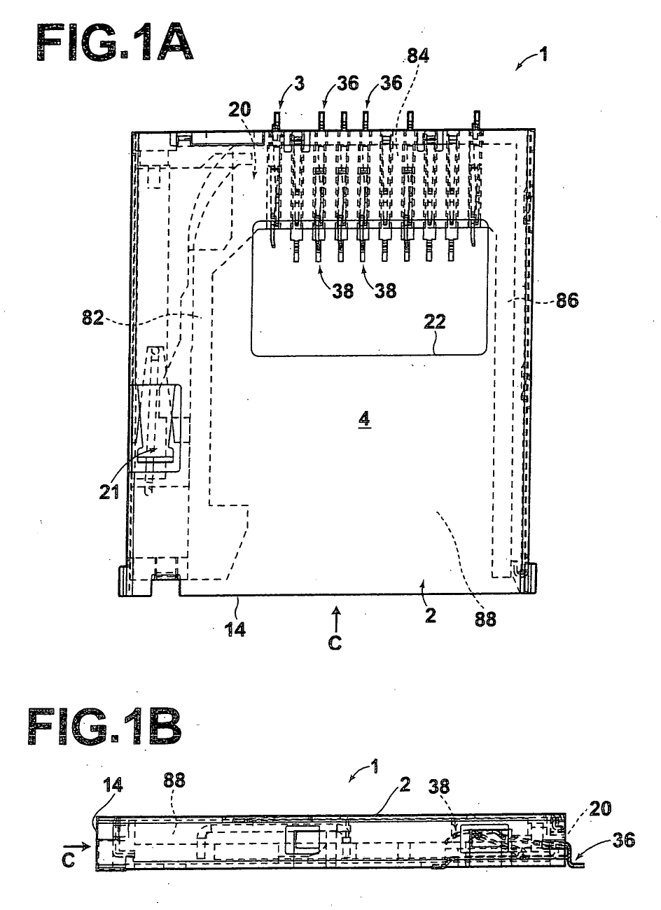

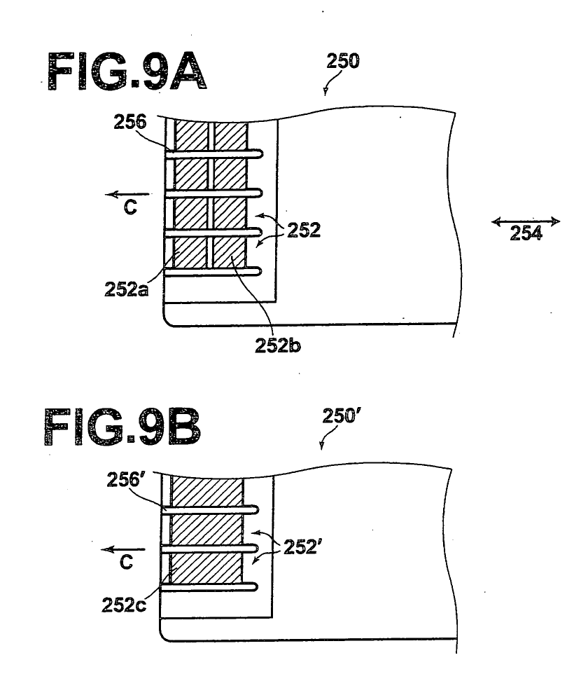

Hereinafter, an electrical connector for cards (hereinafter, simply referred to as “connector”) according to the embodiments of the present invention will be described with reference to the attached drawings. A description will be given with reference to FIGS. 1A and 1B. The connector 1 has a housing 20, molded from an insulative resin and indicated by broken lines and a shell 2 that covers the hosing 20 and is C-shaped in cross section. The shell 2 is formed by stamping and forming a metal plate, such as a plate formed by a copper alloy. The housing 2 has: a rear portion 84 and guide portions 82 and 86, which extend forward from both ends of the rear portion 84. The guide portions 82 and 86 guide a card 250 (second card, refer to FIG. 9A) and a card 250′ (first card, refer to FIG. 9B), which are inserted from the direction of arrow C. Here, “forward” (front portion) refers to the side of the connector 1 toward an engaging portion 14, and “rearward” (rear portion) refers to the side of the connector 1 opposite the front portion, that is, the upper side in FIG. 1.

A plurality of types of contacts 3, which include pluralities of contacts 36 and 38, for contacting the cards 250 and 250′ are mounted at the rear portion 84 of the housing 20. The shell 2 is formed to be of dimensions and a shape such that it covers the upper surface of the rear portion 84, at which the contacts 36 and 38 are provided, and the upper and side surfaces of the guide portions 82 and 86. When the shell 2 is mounted on the housing 20, the rear portion 84, the guide portions 82 and 86, and the shell 2 define a space, that is, a card receiving portion 88. The card receiving portion 88 is open toward the engaging portion 14, and the cards 250 and 250′ are inserted into the card receiving portion 88 through the engaging portion 14, in the direction indicated by arrow C.

The card 250 or 250′, which is inserted into the card receiving portion 88 is stopped and locked at a predetermined position. Thereby, electrodes (conductive pads) of the cards 250 and 250′, to be described later, electrically contact the contacts 36 and 38. When the card 250 or 250′ is to be removed, the lock is released by pressing the card 250 or 250′ in the direction indicated by arrow C, after which the card 250 or 250′ can be pulled out. An ejecting mechanism 21 that locks and releases the cards 250 and 250′ in this manner is integrally provided with the guide portion 82. The ejecting mechanism 21 is disclosed in Japanese Unexamined Patent Publication No. 2002-027099, and is a known mechanism. Because this mechanism is not the main focus of the present invention, a detailed description thereof will be omitted.

Next, the cards 250 and 250′, which are to be inserted into the connector 1, will be described with reference to FIGS. 9A and 9B. FIGS. 9A and 9B are schematic diagrams of the front edges of the cards 250 and 250′, wherein FIG. 9A illustrates the card 250, which has a great number of conductive pads, and FIG. 9B illustrates the card 250′, which has a small number of conductive pads. It can be seen in FIG. 9A that the card 250 (second card) has a plurality of conductive pad regions 252, formed in a direction perpendicular to an insertion/extraction direction 254 of the card 250. A conductive pad 252a and a conductive pad 252b, illustrated by hatching, are arranged along the insertion/extraction direction 254 in each of the regions 252. The conductive pads 252a and 252b contact the contacts 36 and 38, respectively, when the card 250 is inserted into the connector 1.

On the other hand, the card 250′, which has a small number of conductive pads, is provided with a single conductive pad 252c in each conductive pad region 252′ thereof. The regions 252′ are substantially of the same size as the aforementioned regions 252, and are provided at substantially the same positions. Accordingly, the two types of contacts 36 and 38 contact the conductive pads 252c, when the card 250′ is inserted into the connector 1. Each of the regions 252 and 252′ may be separated by ribs 256 and 256′ that extend in the insertion/extraction direction, respectively.

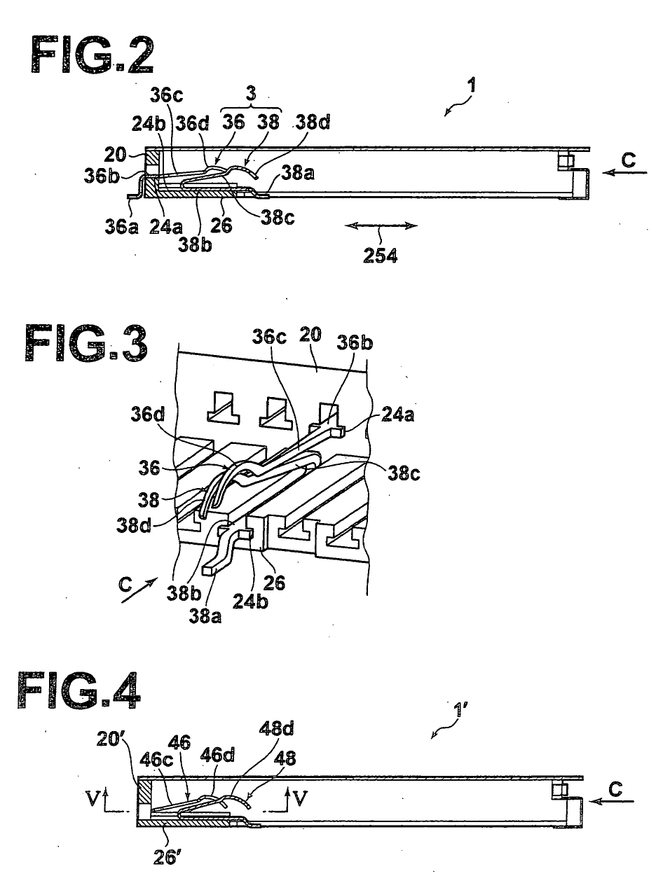

Next, the contacts 36 and 38 of the connector 1 according to the embodiment illustrated in FIG. 1 will be described, with reference to FIG. 2 and FIG. 3. FIG. 2 is a vertical sectional view of the connector 1 of FIG. 1. FIG. 3 is a partial enlarged perspective view that illustrates the mounting state of the contacts 36 and 38 of the connector 1 of FIG. 1. The contacts 3 that contact the electrodes of the cards 250 and 250′ are two types of contacts 36 and 38. Each of the contacts 36 features a press fit portion 36b, which is press fit into a contact mounting groove 24a of the housing 20, a tine portion 36a that extends to the exterior of the housing 20 from the press fit portion 36b and is soldered onto a circuit board and an elastic contact arm 36c that extends diagonally upward and forward from the press fit portion 36b. The contact arm 36c has a contact point portion 36d, which is an upwardly convex portion at the distal end of the contact arm 36c.

Each of the contacts 38 has a press fit portion 38b, which is press fit into a contact mounting groove 24b along a bottom wall 26 of the housing 20, a tine portion 38a that extends forward from the press fit portion 38b and a contact arm 38c, which is bent back from the rear end of the press fit portion 38b to extend diagonally upward and forward. The contact arm 38c also has an upwardly convex contact point portion 38d. What is important here is that the positions of the contact point portions 36d and 38d are shifted along the insertion/extraction direction 254, within the regions in which the conductive pads are provided. That is, the contact point portions 36d and 38d are positioned relatively forward and relatively rearward with respect to each other.

Next, contacts 46 and 48 of a connector 1′ according to a second embodiment of the present invention will be described with reference to FIG. 4 and FIG. 5. FIG. 4 is a vertical sectional view of the connector 1′. FIG. 5 is a partial sectional view of the connector 1′, taken along line V-V of FIG. 4. In the first embodiment, the two types of contacts 36 and 38 are substantially aligned along the insertion/extraction direction 254. However, in the second embodiment, contact point portions 46d and 48d of the contacts 46 and 48 is separated within the regions at which the conductive pads are provided such that they are separated in a direction that intersects with the insertion/extraction direction 254. The contacts 48 are of the same shapes as that of the contacts 38, and are mounted in a housing 20′ in the same manner. The distal ends of the contacts 48 are formed to be the contact point portions 48d, which are upwardly convex. Accordingly, descriptions regarding the construction of the parts of the contacts 48 will be omitted.

On the other hand, the contacts 46 are mounted within contact mounting grooves (not shown) different from those for mounting the contacts 48, and have tines (not shown) on the same side as those of the contacts 48. The contacts 46 further include press fit portions (not shown) that extend along a bottom wall 26′ of the housing 20′ and contact arms 46c, which are bent back from the rear ends of the press fit portions such that they extend diagonally upward and forward, similar to those of the contacts 48. Upwardly convex contact point portions 46d are formed at the distal ends of the contact arms 46c. FIG. 5 illustrates the manner in which the contact points 46d and 48d are separated from each other in a direction that intersects with the insertion/extraction direction 254, and also the manner in which the contact points 46d and 48d are positionally shifted in the forward/rearward direction.

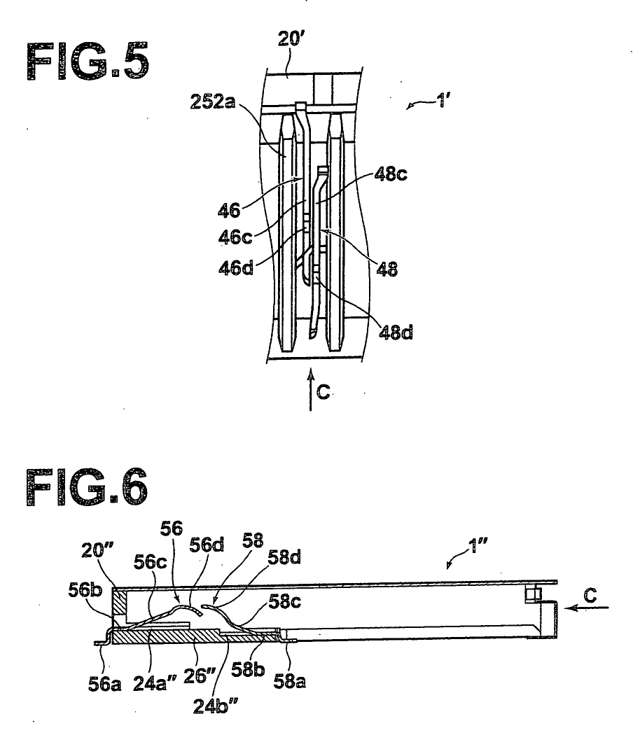

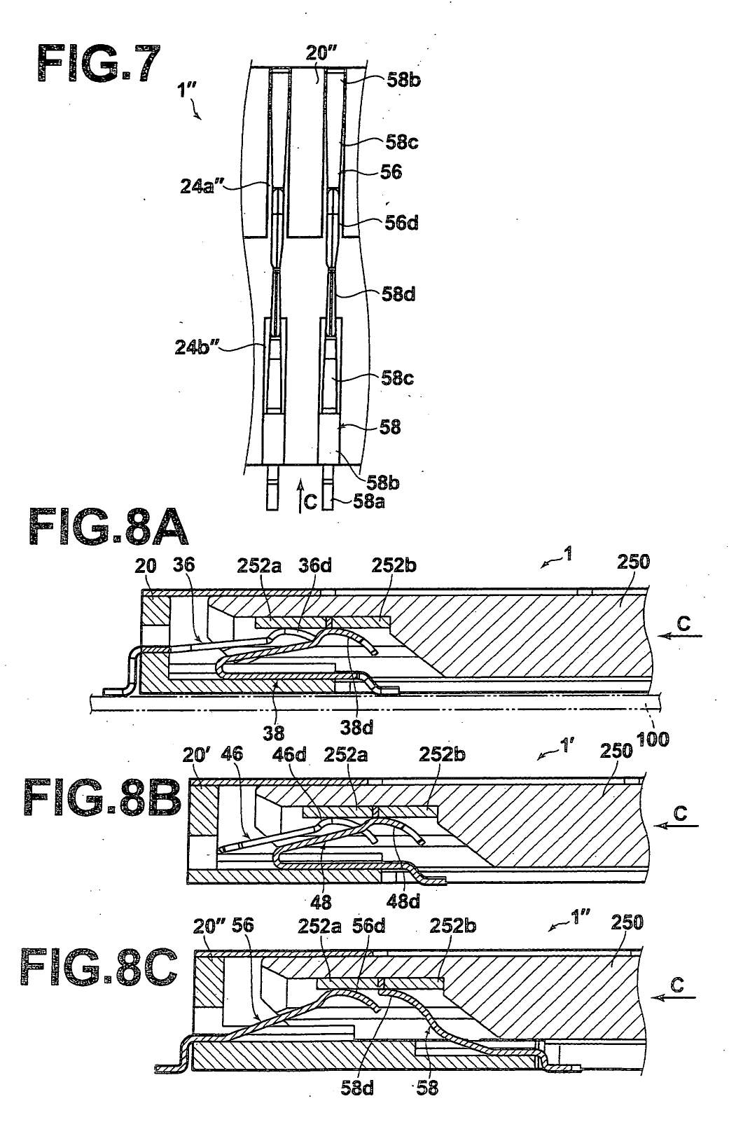

Next, contacts 56 and 58 of a connector 1″ according to a third embodiment of the present invention will be described with reference to FIG. 6 and FIG. 7. FIG. 6 is a vertical sectional view of the connector 1″. FIG. 7 is a partial enlarged plan view of the connector 1″ that illustrates the state in which the contacts 56 and 58 are arranged. The contacts 56 and 58 differ from the contacts of the connectors 1 and 1′ of the first and second embodiments, in that they are provided so that they face each other. The contacts 56 are of a shape similar to that of the contacts 36, and each of the contacts 56 comprises: a tine portion 56a, which is exposed at the rear of a housing 20″; a press fit portion 56b that extends along a bottom wall 26″ of the housing 20″; an elastic contact arm 56c that extends toward the front of the housing 20″; and a contact point portion 56d.

On the other hand, each of the contacts 58 features a tine portion 58a, which is exposed at the front of the bottom wall 26″, a press fit portion 58b that extends along the bottom wall 26″ toward the rear, a contact arm 58c that extends rearward and upward and an upwardly curved contact point portion 58d. The two types of contacts 56 and 58 are mounted within mounting grooves 24a″ and 24b″, respectively. The mounting grooves 24a″ and 24b″ are aligned in the insertion/extraction direction 254. Therefore, the contacts 56 and 58 face each other collinearly. However, the contact point portions 56d and 58d of the contacts 56 and 58 are separated in the frontward/rearward direction along the insertion/extraction direction 254 within the regions at which the conductive pads are provided, so that they respectively correspond to the conductive pads 252a and 252b of the card 250.

Next, the states in which the contacts 36, 38, 46, 48, 56, and 58 of each of the above embodiments contact the conductive pads of the card 250 will be described with reference to FIGS. 8A, 8B, and 8C. FIGS. 8A, 8B, and 8C are partial enlarged sectional views that illustrate states in which the contacts 36, 38, 46, 48, 56, and 58 of the connectors 1, 1′, and 1″ are in contact with the card 250, wherein FIG. 8A illustrates the first embodiment, FIG. 8B illustrates the second embodiment, and FIG. 8C illustrates the third embodiment. FIGS. 8A, 8B, and 8C illustrate cases in which the card 250 of FIG. 9A is inserted into the connectors 1, 1′, and 1″, respectively.

As illustrated in FIG. 8A, in the connector 1 according to the first embodiment, the contact points 36d and 38d of the contacts 36 and 38 contact the conductive pads 252a and 252b, respectively. As illustrated in FIG. 8B, in the connector 1′ according to the second embodiment, the contact points 46d and 48d of the contacts 46 and 48 contact the conductive pads 252a and 252b, respectively. As illustrated in FIG. 8C, in the connector 1″ according to the third embodiment, the contact points 56d and 58d contact the conductive pads 252a and 252b, respectively.

Parallel transmission of signals is enabled by the two types of contacts in each of the above embodiments. Therefore, transfer speed can be approximately doubled. Accordingly, in the case that the card 250 is a recording medium such, as an IC card, in which high volume data, such as video data, is recorded, the data transfer speed can be improved, compared to a case in which the card 250′, which has a small number of contact pads, is employed, while maintaining compatibility. In addition, operating modes (functions) can be added to the card 250, which has a great number of electrodes, while maintaining compatibility with the card 250′, which has a small number of electrodes, due to the increase in transfer paths.

In the case that the card 250′ illustrated in FIG. 9B is utilized instead of the card 250, the regions of the conductive pads 252c of the card 250′ are substantially the same as the combined regions of the conductive pads 252a and 252b of the card 250. Therefore, each pair of the two types of contacts 36 and 38 of the connector 1, the two types of contacts 46 and 48 of the connector 1′, and the two types of contacts 56 and 58 of the connector 1″ contact the same conductive pads 252c, and there are no problems regarding compatibility.

The present invention is constructed as described above. Therefore, two types of cards can be accommodated with a comparatively simple structure, without employing a positional regulating member for cards. In addition, operating modes or additional functions of cards can be added, by the increase in transfer paths.

The connectors 1, 1′, and 1″ of the present invention have been described in detail above. However, the present invention is not limited to the above embodiments, and various changes and modifications are possible. For example, a case has been described in which the conductive pads 252 are divided into the two regions 252a and 252b. However, the conductive pads 252 may be divided into three or more regions. In this case, a number of contacts that correspond to the divided conductive pads will be provided.

What is claimed is:

1. An electrical connector for cards, comprising:
a housing, which is capable of receiving a first card, having conductive pads at predetermined positions, and a second card, having a plurality of conductive pads in at least one region that corresponds to the conductive pads of the first card; and
a plurality of contacts for contacting the plurality of conductive pads of the second card, provided within the region that corresponds to the conductive pads of the first card.

2. The electrical connector for cards as defined in claim 1, wherein contact portions of the plurality of contacts for contacting the plurality of conductive pads of the second card, provided within the region that corresponds to the conductive pads of the first card are arranged along an insertion/extraction direction of the second card.

3. The electrical connector for cards as defined in claim 1, wherein contact portions of the plurality of contacts for contacting the plurality of conductive pads of the second card, provided within the region that corresponds to the conductive pads of the first card are arranged along a direction that intersects an insertion/extraction direction of the second card.

4. The electrical connector for cards as defined in claim 1, wherein the contacts each have a press fit portion which is press fit into a contact mounting groove of the housing.

5. The electrical connector for cards as defined in claim 4, wherein the contacts each have a tine portion extending from the press fit portion to an exterior of the housing.

6. The electrical connector for cards as defined in claim 5, wherein the contacts each have an elastic contact arm extending from the press fit portion.

7. The electrical connector for cards as defined in claim 6, wherein the contacts each have a contact point portion located at a distal end of the contact arm.
